(19) United States
(12) Patent Application Publication
(10) Pub. No.: US 2024/0232288 A1
(43) Pub. Date: Jul. 11, 2024

(54) INFORMATION PROCESSING DEVICE, INFORMATION PROCESSING METHOD, AND COMPUTER PROGRAM PRODUCT

(71) Applicant: KABUSHIKI KAISHA TOSHIBA, Tokyo (JP)

(72) Inventor: Tomoyuki SUZUKI, Shinagawa Tokyo (JP)

(73) Assignee: KABUSHIKI KAISHA TOSHIBA, Tokyo (JP)

(21) Appl. No.: 18/457,591

(22) Filed: Aug. 29, 2023

(30) Foreign Application Priority Data
Jan. 10, 2023 (JP) 2023-001893

(51) Int. Cl. G06F 17/17

(52) U.S. Cl. CPC G06F 17/17

(57) ABSTRACT

According to one embodiment, an information processing device includes a memory and one or more processors. The memory stores time-series data including at least one of dependent and independent variables. The one or more processors are configured to: generate a plurality of nonlinear functions by a plurality of methods based on at least one of the dependent and independent variables; mix the plurality of nonlinear functions to generate a linear regression equation used as a basis function; estimate a coefficient of the linear regression equation; calculate, for a nonlinear function generated by one of the plurality of methods among the plurality of nonlinear functions, a product of the coefficient and a maximum value of the basis function corresponding to the coefficient as a degree of influence; correct the coefficient based on the degree of influence; and output the linear regression equation represented by the corrected coefficient.

### CROSS-REFERENCE TO RELATED APPLICATIONS

This application is based upon and claims the benefit of priority from Japanese Patent Application No. 2023-001893, filed on Jan. 10, 2023; the entire contents of which are incorporated herein by reference.

### FIELD

Embodiments described herein relate generally to an information processing device, an information processing method, and a computer program product.

### BACKGROUND

Technologies for modeling physical phenomena are conventionally known. For example, there is a technology to apply a function identification problem, which is one type of machine learning, and to obtain a mathematical model that describes physical phenomena from time-series data.

However, with conventional technologies, it has been difficult to improve accuracy of generating a physical phenomenon model.

### BRIEF DESCRIPTION OF THE DRAWINGS

FIG. 1 is a diagram illustrating an example of a temperature prediction formula generated from time-series data;

FIG. 2 is a diagram illustrating an example of the left side of a linear regression equation;

FIG. 3 is a diagram illustrating an example of a candidate for one component of a basis function on the right side of the linear regression equation;

FIG. 4 is a diagram illustrating an example of a functional configuration of an information processing device of an embodiment;

FIG. 5 is a flowchart illustrating an example of a method of generating a model of the embodiment;

FIG. 6 is a diagram illustrating a first example of an effect of the embodiment;

FIG. 7 is a diagram illustrating a second example of the effect of the embodiment; and

FIG. 8 is a diagram illustrating an example of a hardware configuration of the information processing device of the embodiment.

### DETAILED DESCRIPTION

In general, according to one embodiment, an information processing device includes a memory and a processor. The memory is configured to store time-series data including at least one of a dependent variable and an independent variable. The one or more processors are coupled to the memory and configured to: generate a plurality of nonlinear functions by a plurality of methods based on at least one of the dependent variable and the independent variable; mix the plurality of nonlinear functions to generate a linear regression equation used as a basis function; estimate a coefficient of the linear regression equation; calculate, for a nonlinear function generated by one of the plurality of methods among the plurality of nonlinear functions, a product of the coefficient and a maximum value of the basis function corresponding to the coefficient as a degree of influence; correct the coefficient based on the degree of influence; and output the linear regression equation represented by the corrected coefficient.

Exemplary embodiments of an information processing device, an information processing method, and a computer program product will be described in detail below with reference to the accompanying drawings. The present invention is not limited to the following embodiments.

There is a method of simply simulating a phenomenon by dividing a complex product/system into a plurality of elements and modeling the relationship of each element. This method applies an equivalent circuit for solving an electric circuit to heat and fluid problems. For example, the method for heat is called a thermal network method, and energy conservation at each node is expressed by the following Formula (1).

$${\sum }_{\begin{matrix}j = 1 \\ j \neq i\end{matrix}}^{N} \frac{1}{{R}_{ij}^{( m )}} ( {T}_{i}^{( m )} - {T}_{j}^{( m )} ) = {Q}_{i}^{( m )} - \frac{{C}_{i}^{( m )}}{Δ t} ( {T}_{i}^{( m )} - {T}_{i}^{( m - 1 )} ) \qquad ( 1 )$$

Here, C is heat capacity, R is heat resistance, Q is calorific value, and N is the number of nodes. By transforming the above Formula (1), the differential equation shown in the following Formula (2) is obtained.

$$\frac{{dT}_{i}}{dt} = \frac{1}{{C}_{i}} \{ {Q}_{i} + {\sum }_{\begin{matrix}j = 1 \\ j \neq i\end{matrix}}^{N} \frac{1}{{R}_{ij}} ( {T}_{j} - {T}_{i} ) \} \qquad ( 2 )$$

When constructing the above Formula (2) deductively, an actual phenomenon and structure are simplified from the viewpoint of physics, and heat resistance, heat capacity, and the like are set. Heat resistance depends not only on the shape and physical properties, but also on state quantities such as temperature and speed thereof. In many cases, there is no theoretical formula, and when there is no theoretical formula, it is necessary to set a formula suitable for the object from among a large number of candidates for empirical formulas.

In sparse identification of nonlinear dynamics (SINDy), which is a development of the function identification problem, under the assumption that a true model can be expressed by a linear combination of nonlinear functions, a time derivative of the variable vector X is given in the form of the following Formula (3).

$$\dot{X} = Θ ( X ) Ξ \qquad ( 3 )$$

Here, X is an m×n matrix. m is the number of time samples, and n is the dimension of the variable X. θ(X) is called a library and includes nonlinear function candidates. Ξ is a vector of sparse coefficients. Coefficients (components of Ξ) corresponding to nonlinear functions not selected as a basis function are represented by 0.

If the library is configured in a form proportional to either term of the above Formula (2), in the application of sparse identification of nonlinear dynamics (SINDy), the temperature prediction formula different for each object (above Formula (2)) can be generated from the time-series data by the following Formula (4).

$$\frac{dT}{dt} = Θ ( T , X ) Ξ \qquad ( 4 )$$

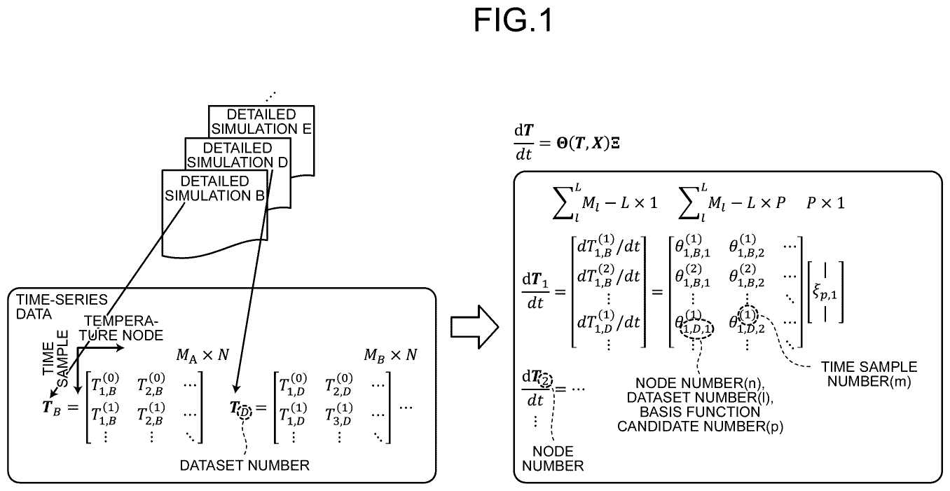

FIG. 1 is a diagram illustrating an example of the temperature prediction formula generated from the time-series data. For example, the time-series data T_{B} is data based on data set B obtained from detailed simulation B. The row of the time-series data T_{B} corresponds to the time sample. The column of the time-series data T_{B} corresponds to the node of the temperature prediction target.

The left side of the temperature prediction formula indicates the time derivative for each node of the temperature prediction target. Each component of θ(X) is represented by a number m identifying the time sample, a number n identifying the node, a number l identifying the data set, and a number p identifying the basis function candidate. The column vector included in θ(X) is the basis function candidate. Ξ is a vector that determines coefficients of the basis function.

However, from the time derivative of X and θ(X) calculated from the time-series data, the desired formula cannot be obtained from the above Formula (2) generated by sequential thresholded least-squares algorithm (STLS), which is a sparse estimation method proposed in S. L. Brunton, J. L. Proctor, J. N. Kutz, “Discovering governing equations from data by sparse identification of nonlinear dynamical systems”, Proc. Natl. Acad. Sci., 113 (2016), pp. 3932-3937. The causes for not being able to obtain the desired formula include the following.
Cause 1: When the time-series data is converted into a form of an ordinary differential equation, each data is handled independently, and an error accumulates during long-term future prediction.
Cause 2: Because of the influence of multicollinearity, efficient sparse estimation cannot be executed and an unstable equation is generated.
Cause 3: In selecting the basis function, it is difficult to optimize thresholds different for each equation (for example, equation for each temperature node).

The cause 1 can be solved by Japanese Patent Application Laid-open No. 2022-167097, and the causes 2 and 3 can be solved by Japanese Patent Application Laid-open No. 2022-167093. However, simply combining Japanese Patent Application Laid-open No. 2022-167097 and Japanese Patent Application Laid-open No. 2022-167093 cannot generate a highly accurate equation. Here, consider the time-series data of the basis function when data with different preprocessing methods are mixed (Japanese Patent Application Laid-open No. 2022-167097).

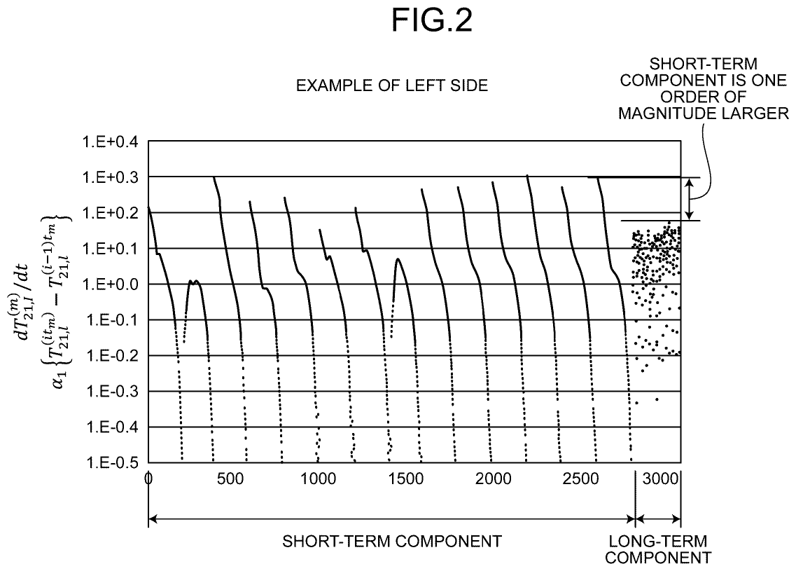

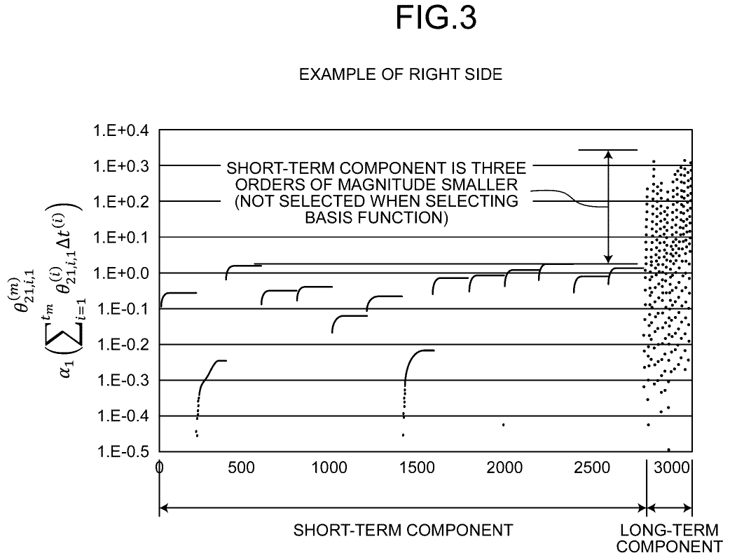

FIG. 2 is a diagram illustrating an example of the left side of a linear regression equation. FIG. 3 is a diagram illustrating an example of a candidate for one component of a basis function on the right side of the linear regression equation. FIG. 2 illustrates a data example of 14 cases of detailed analysis of the left side of the linear regression equation when learning data is created based on Japanese Patent Application Laid-open No. 2022-167097. FIG. 3 illustrates a data example of 14 cases of detailed analysis about one basis function candidate of the right side of the linear regression equation when the learning data is created based on Japanese Patent Application Laid-open No. 2022-167097. The detailed analysis is a non-stationary analysis until the state quantity (temperature) stabilizes, and outputs the state quantity for each time. This is an analysis of 14 cases with different boundary conditions and initial conditions. The horizontal axis of FIGS. 2 and 3 illustrates the number to identify data (set of detailed analysis number and time). The data is classified by case of detailed analysis and arranged in ascending order of time. The vertical axis is a time derivative component of temperature (short-term component) and a fixed interval fluctuation component of temperature (long-term component) calculated based on Japanese Patent Application Laid-open No. 2022-167097. The case of detailed analysis switches at a place where the value on the vertical axis changes stepwise.

It can be seen that when different types of data are normalized and then combined (Japanese Patent Application Laid-open No. 2022-167097) as in the following Formula (5), the difference increases. This indicates that it is difficult to solve the cause 3 described above with application of hypothesis examination.

$$α {\sum }_{i} Δ {T}_{t = 0} = {\sum }_{i} \dot{T} \qquad ( 5 )$$

Here, i is the number of data, α is the weight, and α>1. By the above Formula (5), the sum total of the time derivative values of the variable included in the learning data is greater than the sum total of the differences indicating the fluctuation from the initial value of the variable.

Consider the following t examination. Assuming that the null hypothesis is coefficient=0, the t value in the multiple regression analysis is expressed by the following Formula (6). Significance is often determined at about 2 (95% confidence interval) or more.

$$t \frac{{β}_{i} - 0}{\sqrt{{SS}^{ii} \times {SS}_{e} / ( n - p )}} = \frac{{β}_{i} - 0}{\sqrt{{SS}^{ii} \times {V}_{e}}} = \frac{{β}_{i}}{\sqrt{{SS}^{ii}} \sqrt{{V}_{e}}} ∝ \frac{{β}_{i}}{\sqrt{{SS}^{ii}}} \qquad ( 6 )$$

Here, Vₑ is the error variance SSₑ/(n−p). p is the number of basis functions. n−p is the degree of freedom of error. SSₑ is the residual sum of squares expressed by the following Formula (7).

$${SS}_{e} = \sum {( {y}_{i} - {\hat{y}}_{i} )}^{2} \qquad ( 7 )$$

SSⁱⁱ is a diagonal element of the inverse matrix of the matrix SSᵢⱼ of the following Formula (8). The matrix SSᵢⱼ=Σxᵢₖxⱼₖ is a p-order square matrix of the sum of squared deviations and the sum of deviation products.

$${SS}_{ij} = ( \begin{matrix}{SS}_{11} & {SS}_{12} & … & {SS}_{1 p} \\ {SS}_{21} & {SS}_{22} & … & {SS}_{2 p} \\ ⋮ & ⋮ & ⋱ & ⋮ \\ {SS}_{p 1} & {SS}_{p 2} & … & {SS}_{pp}\end{matrix} ) \qquad ( 8 )$$

Since the error variance is common to all the basis function, a method of implementing the basis function selection for each equation by using a common tol can be considered by using a value proportional to the standard error of the following Formula (9) and making the following Formula (10).

$$\sqrt{S \text{?} \times {V}_{e}} \qquad ( 9 )$$

$${ξ}_{p , n} / \sqrt{S \text{?}} < tol \qquad ( 10 )$$

$$\text{?} \text{indicates text missing or illegible when filed}$$

However, since the range of the value of the basis function of the short-term component (for example, time derivative of temperature) and the range of the value of the basis function of the long-term component (for example, amount of change from the initial temperature) are significantly different, the matrix of the sum of squared deviations and the sum of deviation products becomes almost meaningless. Therefore, the selection of the basis function candidate by hypothesis examination does not work effectively.

Therefore, in Japanese Patent Application Laid-open No. 2022-167093, the maximum value in the time-series data is regarded as a representative value of the basis function, specifically, the degree of influence is expressed as: magnitude of term=coefficient ξₖⱼ×representative value of the basis function maxᵢ|θᵢₖ|. The basis function has been selected by correcting to 0 the coefficient of the basis function with the degree of influence equal to or less than the threshold expressed on the right side of the following Formula (11).

$${ξ}_{kj} {max}_{i} \vert {θ}_{ik} \vert \leq tol \times {\sum }_{k} ( {ξ}_{kj} {max}_{i} \vert {θ}_{ik} \vert ) \qquad ( 11 )$$

However, when data of different preprocessing methods is mixed, there is a possibility that the value of the long-term component will be selected as the representative value of the basis function candidate (following Formula (12)). This can be understood from the fact that the value of the long-term component is several orders of magnitude larger than the value of the short-term component in FIG. 3.

$${ξ}_{p , n} {max}_{m} \vert {θ}_{n , p}^{( m )} \vert \qquad ( 12 )$$

The degree of influence of the left side (time derivative of temperature in the embodiment) on the coefficient estimation (sum of squares error) is dominated by the short-term component due to the influence of normalization. Therefore, selection of the normalized (corrected) value of the long-term component as the representative value of the basis function candidate is not suitable as a “representative value of the magnitude of the term” that expresses the degree of influence on the left side (time derivative of temperature in the embodiment) (physically strange).

Details of an operation example of the information processing device of the embodiment that can further improve the accuracy of generating the physical phenomenon model will be described below.

### Example of Functional Configuration

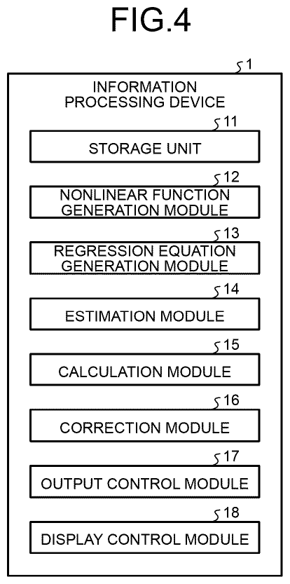

FIG. 4 is a diagram illustrating an example of a functional configuration of an information processing device 1 of the embodiment. The information processing device 1 of the embodiment includes a storage unit 11, a nonlinear function generation module 12, a regression equation generation module 13, an estimation module 14, a calculation module 15, a correction module 16, an output control module 17, and a display control module 18.

The storage unit 11 stores the time-series data including at least one of a dependent variable and an independent variable. The dependent variable (objective variable) is a variable determined depending on the independent variable (explanatory variable). The independent variable is a variable indicating a factor of a change in the dependent variable. The dependent variable is, for example, temperature of an electronic component, heat sink, and the like. The independent variable is, for example, the wind speed indicating wind strength of a fan cooling an electronic component and pressure difference, a current flowing through an electronic component, a voltage input to an electronic component, and the like.

In the information processing device 1 of the embodiment, the value of the dependent variable is represented in units unified for each physical quantity indicated by the dependent variable. For example, when the physical quantity is weight, the dependent variable represented by kg and the dependent variable represented by g are not mixed and unified into kg or g. Similarly, the value of the independent variable is represented in units unified for each physical quantity indicated by the independent variable.

Note that the storage unit 11 may store a plurality of types of time-series data. At least one of an initial condition and boundary condition may be different for the plurality of types of time-series data.

The nonlinear function generation module 12 generates a plurality of nonlinear functions based on at least one of the dependent variable and the independent variable by a plurality of methods. The nonlinear function generation module 12 generates the nonlinear function, for example, based on the temperature Tᵢ at the position i and the temperature Tⱼ at the position j. The plurality of methods include, for example, a time derivative method indicating the short-term component and a difference method indicating fluctuation of the long-term component.

The regression equation generation module 13 generates a linear regression equation by mixing a plurality of nonlinear functions generated by the nonlinear function generation module 12 for use as a basis function.

The estimation module 14 estimates the coefficient of the linear regression equation generated by the regression equation generation module 13. For example, the estimation module 14 estimates the coefficient of the linear regression equation by the machine learning using a value indicating the short-term component (for example, time derivative value) and the difference indicating the long-term component (for example, difference indicating the fluctuation from the initial value of the variable) as learning data. At this time, the sum total of time derivative values included in the learning data is made larger than the sum total of differences indicating the long-term component (above Formula (5)).

The calculation module 15 calculates, for a nonlinear function generated by one of the above-described plurality of methods among the plurality of nonlinear functions, the degree of influence based on the magnitude of the term (coefficient×basis function). The value of the basis function (for example, Tᵢ−Tⱼ) changes over time. Therefore, the maximum value in the time-series data is regarded as a representative value of the basis function, specifically, the degree of influence is expressed as: magnitude of term=coefficient ξₖⱼ×representative value of basis function maxᵢ|θᵢₖ|. That is, the calculation module 15 calculates the product of the coefficient estimated by the estimation module 14 and the maximum value of the basis function corresponding to the coefficient as the degree of influence.

The correction module 16 corrects the coefficient based on the degree of influence calculated by the calculation module 15. For example, the correction module 16 corrects the coefficient of the basis function with the degree of influence equal to or less than a threshold to zero. At this time, when learning is executed with data that is a mixture of data that has undergone different preprocessing (when a plurality of nonlinear functions is generated by a plurality of methods), the correction module 16 targets (either) one data before mixing as the representative value of the basis function candidate in the magnitude of the term (following Formula (13)).

$${max}_{m} \vert {θ}_{n , p}^{( m )} \vert , \qquad ( 13 )$$

$${θ}_{n , p}^{( m )} ∈ {S}_{Short}$$

Here, S_{Short} indicates an area of the short-term component. In the example of thermal hydraulic analysis of the embodiment, the representative value of the basis function candidate preferably targets data of the short-term component (see FIGS. 2 and 3). Here, the threshold for simultaneous equations is, for example, the following Formula 14 or (15).

$${tol}_{n} \times {\sum }_{p} ( {ξ}_{p , n} {max}_{m} \vert {θ}_{n , p}^{( m )} \vert ) \qquad ( 14 )$$

$${tol}_{n} \times {max}_{p} ( {ξ}_{p , n} {max}_{m} \vert {θ}_{n , p}^{( m )} \vert ) \qquad ( 15 )$$

Here, “tolₙ” is a hyperparameter and tolₙ<1 “m” indicates time, and “n” indicates the space (temperature node) number (equation number). “p” is a number to identify the basis function. Note that in Japanese Patent Application Laid-open No. 2022-167093, the same hyperparameter tol is used at all temperature nodes.

When a predetermined convergence condition is satisfied, the output control module 17 outputs the linear regression equation represented by the modified coefficient. The predetermined convergence condition is, for example, the number of iterations of the machine learning process and the like.

The display control module 18 displays display information on a display device. For example, the display control module 18 displays the linear regression equation output by the output control module 17. For example, the display control module 18 displays basis function candidates on the display device, and receives designation of the basis function used to generate the linear regression equation (for example, column vector included in the library θ(X) of the above Formula (3)) from the basis function candidates.

### Example of Method of Generating Model

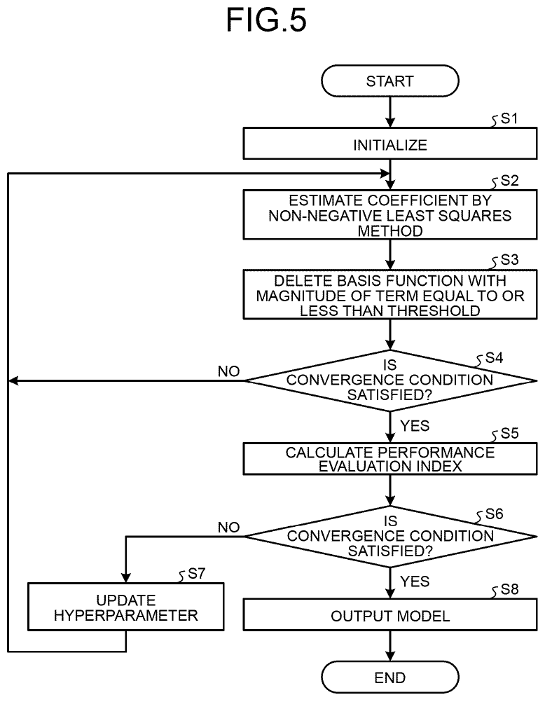

FIG. 5 is a flowchart illustrating an example of a method of generating a model of the embodiment. To begin with, the information processing device 1 initializes data to be used when executing machine learning on the model (for example, hyperparameter and the like) (step S1).

Next, the estimation module 14 estimates the coefficient of the linear regression equation generated by the regression equation generation module 13 by non-negative least squares method by the following Formula (16) (step S2).

$${min}_{ξ} {‖ \dot{X} - Θ ( X ) Ξ ‖}_{2}^{2} s . t . 0 ≦ {ξ}_{kj} \qquad ( 16 )$$

Here, the reason for using the non-negative least squares method in step S2 will be described. In the conventional sequential threshold least squares method, the coefficient estimation is executed by the least squares method. However, if the correlation between the basis functions (≈ variables) is very high and the number of learning data is small, the coefficient estimation may not be successful and the estimated value of the coefficient may be very large.

Next, the calculation module 15 calculates the above-described degree of influence (magnitude of term), and the correction module 16 corrects the coefficient of the basis function with the degree of influence equal to or less than the threshold to 0, thereby deleting the basis function equal to or less than the threshold (step S3). Specifically, first, the calculation module 15 determines a target for calculating the degree of influence (magnitude of term). The embodiment targets the data of the short-term component (see FIGS. 2 and 3). For the short-term component data, the correction module 16 corrects the coefficient of the basis function with the degree of influence equal to or less than the threshold by the above Formula (14) or (15) to zero.

Next, the correction module 16 determines whether the result of the coefficient estimation and correction process satisfies the convergence condition (step S4).

The convergence condition is, for example, the number of times the coefficient estimation and correction process are executed. In this case, the estimation module 14 updates the linear regression equation with the coefficient corrected by the correction module 16, and then estimates again the coefficient of the updated linear regression equation. Next, the calculation module 15 updates the degree of influence by the product of the coefficient of the updated linear regression equation and the maximum value of the basis function corresponding to the coefficient of the updated linear regression equation. Then, the correction module 16 again corrects the coefficient of the updated linear regression equation based on the updated degree of influence. The information processing device 1 repeats the estimation of the coefficient, the calculation of the degree of influence, and the correction of the coefficient predetermined times.

When the convergence condition is not satisfied (step S4, No), the process returns to step S2. When the convergence condition is satisfied (step S4, Yes), the output control module 17 calculates a performance evaluation index of the model (step S5). Next, the output control module 17 determines whether the learned model satisfies the convergence condition (step S6). The convergence condition is, for example, the number of times the model learning process is executed. For example, the convergence condition is whether the performance evaluation index calculated by the process of step S5 is greater than a predetermined evaluation threshold. When the convergence condition is not satisfied (step S6, No), the hyperparameter is updated (step S7), returning to step S2.

When the convergence condition is satisfied (step S6, Yes), the output control module 17 outputs the model (step S8).

### Description of Effect

Next, the accuracy of the model generated by the information processing device 1 of the embodiment will be described.

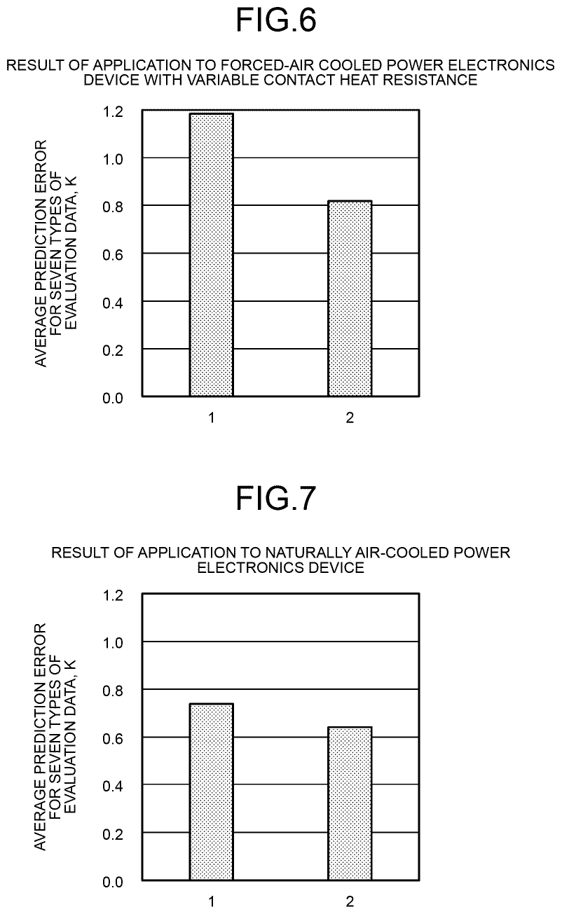

FIG. 6 is a diagram illustrating a first example of an effect of the embodiment. The example of FIG. 6 illustrates an example of application to a forced air-cooled power electronics device with variable contact heat resistance. The vertical axis illustrates the average prediction error for seven types of evaluation data simulated with different numerical values such as boundary conditions and heat generation conditions. Data 1 on the horizontal axis illustrates the case where the learning method of Japanese Patent Application Laid-open No. 2022-167093 is used. Data 2 on the horizontal axis illustrates the case where the learning method of the embodiment is used. As illustrated in FIG. 6, by the learning method of the embodiment, the average prediction error can be suppressed more than before.

FIG. 7 is a diagram illustrating a second example of the effect of the embodiment. The example of FIG. 7 illustrates an example of application to a naturally air-cooled power electronics device. The vertical axis illustrates the average prediction error for seven types of evaluation data simulated with different numerical values such as boundary conditions and heat generation conditions. Data 1 on the horizontal axis illustrates the case where the learning method of Japanese Patent Application Laid-open No. 2022-167093 is used. Data 2 on the horizontal axis illustrates the case where the learning method of the embodiment is used. As illustrated in FIG. 7, by the learning method of the embodiment, the average prediction error can be suppressed more than before.

As described above, in the information processing device 1 of the embodiment, the storage unit 11 stores the time-series data including at least one of the dependent variable and the independent variable. The nonlinear function generation module 12 generates a plurality of nonlinear functions based on at least one of the dependent variable and the independent variable by a plurality of methods. The regression equation generation module 13 generates the linear regression equation used as the basis function by mixing the plurality of nonlinear functions. The estimation module 14 estimates the coefficient of the linear regression equation. The calculation module 15 calculates, for a nonlinear function generated by one of the plurality of methods among the plurality of nonlinear functions, the product of the coefficient and the maximum value of the basis function corresponding to the coefficient as the degree of influence. The correction module 16 corrects the coefficient based on the degree of influence. Then, the output control module 17 outputs the linear regression equation represented by the corrected coefficient.

With this configuration, the information processing device 1 of the embodiment can further improve the accuracy of generating the physical phenomenon model.

Note that the embodiment has described the case where the information processing device 1 generates the linear regression equation of the thermal model, but may generate the linear regression equation of other physical phenomenon model (for example, electrical resistance, physical deformation).

Finally, an example of a hardware configuration of the information processing device 1 of the embodiment will be described.

### Example of Hardware Configuration

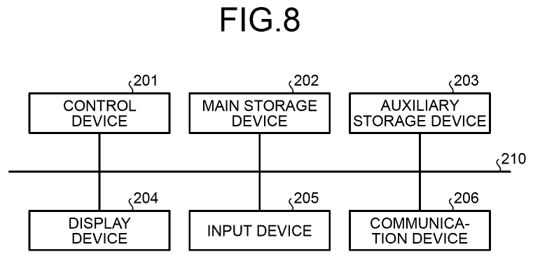

FIG. 8 is a diagram illustrating an example of the hardware configuration of the information processing device 1 of the embodiment.

The information processing device 1 of the embodiment includes a control device 201, a main storage device 202, an auxiliary storage device 203, a display device 204, an input device 205, and a communication device 206. The control device 201, the main storage device 202, the auxiliary storage device 203, the display device 204, the input device 205, and the communication device 206 are connected via a bus 210.

The control device 201 executes a program read from the auxiliary storage device 203 to the main storage device 202. The main storage device 202 is a memory such as a read-only memory (ROM) and a random-access memory (RAM). The auxiliary storage device 203 is a hard disk drive (HDD), a memory card, and the like.

The display device 204 displays display information. The display device 204 is, for example, a liquid crystal display or the like. The input device 205 is an interface for operating the information processing device 1. The input device 205 is, for example, a keyboard, a mouse, or the like. When the information processing device 1 is a smart device, such as a smartphone and a tablet-type terminal, the display device 204 and the input device 205 are, for example, a touch panel.

The communication device 206 is an interface for communicating with other devices and the like.

The program to be executed by the information processing device 1 of the embodiment is a file in an installable or executable format, and is recorded in a computer-readable storage medium such as a CD-ROM, memory card, CD-R, and DVD, and is provided as a computer program product.

A configuration may be adopted such that the program to be executed by the information processing device 1 of the embodiment is stored on a computer connected to a network such as the Internet and is provided by downloading via the network. A configuration may be adopted such that the program to be executed by the information processing device 1 of the embodiment is provided via a network such as the Internet without downloading.

A configuration may be adopted such that the program of the information processing device 1 of the embodiment is provided by being incorporated into a ROM or the like in advance.

The program to be executed by the information processing device 1 of the embodiment has a modular configuration including functional blocks that can also be implemented by the program among the functional blocks described above (FIG. 4). As actual hardware of each of the functional blocks, the control device 201 reads and executes the program from a storage medium, whereby each of the functional blocks is loaded on the main storage device 202. That is, each of the functional blocks is generated on the main storage device 202.

Note that part or all of the functional blocks described above may not be implemented by software, but may be implemented by hardware such as an integrated circuit (IC).

When implementing each function by using a plurality of processors, each processor may implement one of the functions, or may implement two or more of the functions.

The operational mode of the information processing device 1 of the embodiment may be arbitrary. The information processing device 1 of the embodiment may operate, for example, as a cloud system on a network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a memory configured to store time-series data including at least one of a dependent variable and an independent variable; and
one or more processors coupled to the memory and configured to:
generate a plurality of nonlinear functions by a plurality of methods based on at least one of the dependent variable and the independent variable;
mix the plurality of nonlinear functions to generate a linear regression equation used as a basis function;
estimate a coefficient of the linear regression equation;
calculate, for a nonlinear function generated by one of the plurality of methods among the plurality of nonlinear functions, a product of the coefficient and a maximum value of the basis function corresponding to the coefficient as a degree of influence;
correct the coefficient based on the degree of influence; and
output the linear regression equation represented by the corrected coefficient.

2. The device according to claim 1, wherein
the one or more processors are configured to:
update the linear regression equation with the corrected coefficient, and then estimate again a coefficient of the updated linear regression equation;
update the degree of influence by a product of the coefficient of the updated linear regression equation and a maximum value of the basis function corresponding to the coefficient of the updated linear regression equation; and
again correct the coefficient of the updated linear regression equation based on the updated degree of influence, and repeat the estimation of the coefficient, the calculation of the degree of influence, and the correction of the coefficient by predetermined times.

3. The device according to claim 1, wherein
the plurality of methods includes a method by a time derivative indicating a short-term component and a method by a difference indicating fluctuation of a long-term component,
the one or more processors are configured to estimate the coefficient of the linear regression equation by machine learning using the time derivative and the difference as learning data, and
a sum total of the time derivative included in the learning data is greater than a sum total of the difference.

4. The device according to claim 3, wherein
the one or more processors are configured to calculate, for a nonlinear function generated by the method by the time derivative indicating the short-term component among the plurality of nonlinear functions, the product of the coefficient and the maximum value of the basis function corresponding to the coefficient as the degree of influence.

5. The device according to claim 1, wherein
the one or more processors are configured to correct the coefficient of the basis function with the degree of influence equal to or less than a threshold to zero.

6. The device according to claim 1, wherein
the one or more processors are configured to estimate the coefficient by a non-negative least squares method.

7. The device according to claim 1, wherein
a value of the dependent variable is represented by a unit unified for each physical quantity indicated by the dependent variable, and
a value of the independent variable is represented by a unit unified for each physical quantity indicated by the independent variable.

8. The device according to claim 1, wherein
the one or more processors are further configured to display a candidate for the basis function on a display device and receive designation of the basis function used to generate the linear regression equation from the candidate for the basis function.

9. An information processing method comprising:
storing time-series data including at least one of a dependent variable and an independent variable;
generating a plurality of nonlinear functions by a plurality of methods based on at least one of the dependent variable and the independent variable;
mixing the plurality of nonlinear functions to generate a linear regression equation used as a basis function;
estimating a coefficient of the linear regression equation;
calculating, for a nonlinear function generated by one of the plurality of methods among the plurality of nonlinear functions, a product of the coefficient and a maximum value of the basis function corresponding to the coefficient as a degree of influence;
correcting the coefficient based on the degree of influence; and
outputting the linear regression equation represented by the corrected coefficient.

10. A computer program product comprising a non-transitory computer-readable medium including programmed instructions, the instructions causing a computer to execute:
storing time-series data including at least one of a dependent variable and an independent variable;
generating a plurality of nonlinear functions by a plurality of methods based on at least one of the dependent variable and the independent variable;
mixing the plurality of nonlinear functions to generate a linear regression equation used as a basis function;
estimating a coefficient of the linear regression equation;
calculating, for a nonlinear function generated by one of the plurality of methods among the plurality of nonlinear functions, a product of the coefficient and a maximum value of the basis function corresponding to the coefficient as a degree of influence;
correcting the coefficient based on the degree of influence; and
outputting the linear regression equation represented by the corrected coefficient.
